(19) United States
(12) Patent Application Publication
(10) Pub. No.: US 2016/0047535 A1
(43) Pub. Date: Feb. 18, 2016

(54) LED LAMP WITH DIRECTIONAL ILLUMINATION

(71) Applicant: ELB ELECTRONICS, INC., Arcadia, CA (US)

(72) Inventor: Steven Purdy, Johns Creek, GA (US)

(21) Appl. No.: 14/825,099

(22) Filed: Aug. 12, 2015

Related U.S. Application Data
(60) Provisional application No. 62/036,198, filed on Aug. 12, 2014.

(51) Int. Cl. F21V 21/30; F21V 5/04; F21V 23/00; F21V 19/00; F21K 99/00; F21V 23/06

(52) U.S. Cl. CPC F21V 21/30; F21K 9/13; F21V 23/06; F21V 23/002; F21V 19/0095; F21V 19/0035; F21V 5/04; F21Y 2103/003

(57) ABSTRACT

A rotatable single ended compact LED lamp for use in a light fixture. The device includes a single ended LED lamp with a circuit board with LEDs that is positioned in a transparent or translucent cover, and a swivel base to which the circuit board and the transparent or translucent cover are non-rotatably connected. An end cap is rotatably coupled to the swivel base, the end cap having electrical prongs extends therefrom. A rotation position selection device is included for positioning the single ended LED lamp, the transparent or translucent cover, and its swivel base in one of a plurality of rotational orientations relative to the end cap, wherein when the single ended LED lamp, the transparent or translucent cover, and its swivel base are rotated relative to the end cap, a rotational orientation of the single ended LED lamp relative to the end cap is changed.

### CROSS-REFERENCE TO RELATED APPLICATION(S)

This application claims priority from U.S. Provisional Patent Application No. 62/036,198 filed Aug. 12, 2014, entitled “LED LAMP WITH DIRECTIONAL ILLUMINATION.”

### FIELD OF THE INVENTION

The invention relates to LED lamps fitted with multiple pin inline sockets which are intended for use in lighting fixtures, and more particularly to LED lamps with a rotatable end cap that allows the LED lamp to be rotated to align the LED lamp as desired.

### BACKGROUND OF THE INVENTION

LED lamps having tubular sections intended for use as fluorescent tubular replacement lamps do not project light in 360 degrees around the tubular sections as do fluorescent lamps. This limits the application of LED lamps in lighting fixtures in which the positioning of the fluorescent lamp socket is not positioned in parallel with the plane of the fixture. This limitation is amplified when using multi-pin sockets which are more rectangular in design such as the single ended compact fluorescent lamps or long single turn compact fluorescent lamps. Many fluorescent fixture designs position the sockets in which the light illumination is from the side of the tube instead of the wider surface area of the lamp.

An example of a prior art single ended compact fluorescent lamp with 360 degree illumination is shown in FIGS. 1A and 1B. In contrast, LED lamps are more energy efficient, but illumination is limited to a field of about a maximum of 270 degrees due to the direction nature of the light emitted from the diodes located on the circuit board located in the LED lamp.

Improper lighting can occur when LED lamps do not have their circuit board LEDs facing parallel to the surface intended to be illuminated. For example, this type of problem can occur when LED lamps are installed in designer or custom light fixtures where the fixture sockets and lamp pins incorrectly align such that the LED side of the circuit board does not face parallel to the intended illuminating surface. FIGS. 2, 3 and 4 diagrammatic examples of prior art fluorescent lamp luminaries with replacement single ended compact fluorescent lamps installed. In these examples the sockets of the LED lamps align with the stationary socket plugs in the light fixture such that the LEDs are incorrectly oriented so that the illumination is not parallel to a surface intended to be illuminated, in this case, straight down. As such, there can be problems associated with installing replacement single ended compact fluorescent lamps or long single turn compact fluorescent lamps into certain fluorescent lamp luminaries.

### SUMMARY OF THE INVENTION

The present invention eliminates the issue presented with affixing standard LED lamps in fluorescent lamp light fixtures that do not have their sockets positioned in the ideal position so that the replacement LED lamps fixtures inserted therein will be oriented such that light will project along a horizontal plane. The LED lamp of the invention has individual LEDs extending from the same side of the circuit board as a standard LED lamp but provides a rotatable end cap and swivel base for adjusting the 270 degree illumination field of between about 0-90 degrees.

The rotational capability of the modified LED lamp provides the installer the ability to adjust the LED lamp until the desired illumination position is attained which preferably is where the LED circuit board face is parallel to the intended illuminating surface. By providing an LED lamp which can be adjusted, existing light fixtures can be used as-is rather than the alternative choice of repositioning of the lamp sockets, or replacing the luminaries, which can be cost prohibitive.

An exemplary embodiment the invention provides a rotatable single ended compact LED lamp for use in a light fixture, the rotatable single ended compact LED lamp comprising: a single ended LED lamp having (a) a circuit board with a top surface and with light emitting diodes located on the circuit board to project light away from the top surface thereof, the circuit board having a first end with electrical leads and a second end opposite the first end, there being an imaginary circuit board plane that is parallel to the top surface of the circuit board, (b) a transparent or translucent cover with a first end and a second end, the transparent or translucent cover being spaced over the circuit board, and (c) a swivel base having a rear side and a front side that is opposite the rear side, the circuit board and the transparent or translucent cover being non-rotatably connected at their second ends to the rear side of a swivel base; an end cap having a front side with electrical connectors, and a rear side opposite the front side, the end cap having an imaginary longitudinal plane passing through the front side and the rear side, the end cap being rotatably coupled at its rear side to the front side of the swivel base; and a rotation position selection device for positioning the single ended LED lamp, the transparent or translucent cover, and its swivel base in one of a plurality of rotational orientations relative to the end cap, wherein when the single ended LED lamp, the transparent or translucent cover, and its swivel base are rotated relative to the end cap, a rotational orientation of the single ended LED lamp relative to the end cap is changed and the imaginary circuit board plane will rotate relative to the imaginary end cap longitudinal plane.

Another exemplary embodiment the invention provides a rotatable single ended compact LED lamp for use in a light fixture, the rotatable single ended compact LED lamp comprising: a single ended LED lamp having (a) a circuit board with a top surface and with light emitting diodes located on the circuit board to project light away from the top surface thereof, the circuit board having a first end with electrical leads and a second end opposite the first end, there being an imaginary circuit board plane that is parallel to the top surface of the circuit board, (b) a transparent or translucent cover with a first end and a second end, the transparent or translucent cover being spaced over the circuit board, and (c) a swivel base having a rear side and a front side that is opposite the rear side, the circuit board and the transparent or translucent cover being non-rotatably connected at their second ends to the rear side of a swivel base; an end cap having a front side with electrical connectors, and a rear side opposite the front side, the end cap having an imaginary longitudinal plane passing through the front side and the rear side, the end cap being rotatably coupled at its rear side to the front side of the swivel base; and a rotation position selection device for positioning the single ended LED lamp, the transparent or translucent cover, and its swivel base in one of a plurality of rotational orientations relative to the end cap, wherein when the single ended LED lamp, the transparent or translucent cover, and its swivel base are rotated relative to the end cap, a rotational orientation of the single ended LED lamp relative to the end cap is changed and the imaginary circuit board plane will rotate relative to the imaginary end cap longitudinal plane; wherein one of the swivel base and the end cap include a protrusion and the other of the swivel base and the end cap include a recess into which the protrusion rotatably engages along a rotational axis, wherein the electrical leads comprise flexible wires, which flexible wires pass through the protrusion and recess and are electrically connected to the electrical connectors so that electrical power may be provided to the single ended LED lamp regardless of the rotational orientation of the single ended LED lamp relative to the end cap.

Yet another exemplary embodiment the invention provides a rotatable single ended compact LED lamp for use in a light fixture, the rotatable single ended compact LED lamp comprising: a single ended LED lamp having a circuit board with light emitting diodes located on the circuit board, a transparent or translucent cover which covers the circuit board and light emitting diodes, and a swivel base to which the circuit board and the transparent or translucent cover are non-rotatably connected; an end cap which is rotatably coupled to the swivel base, the end cap having electrical prongs extends therefrom; and a rotation position selection device for positioning the single ended LED lamp, the transparent or translucent cover, and its swivel base in one of a plurality of rotational orientations relative to the end cap, wherein when the single ended LED lamp, the transparent or translucent cover, and its swivel base are rotated relative to the end cap, a rotational orientation of the single ended LED lamp relative to the end cap is changed.

These and other features of the invention are described below.

### BRIEF DESCRIPTION OF THE DRAWINGS

FIG. 1A is a top plan view of a prior art single ended compact fluorescent lamp.

FIG. 1B is a cross-section view of the prior art single ended compact fluorescent lamp along view lines 1A-1A of FIG. 1A.

FIG. 2 is a side view of an exemplary prior art fluorescent lamp luminary having two prior art single ended compact LED lamps installed and shows the resulting incorrect light projection.

FIG. 3 is a side view of another exemplary prior art fluorescent lamp luminary having single ended compact LED lamp installed and shows the resulting incorrect light projection with a prior art single ended compact LED lamp installed in any of three orientations.

FIG. 4 is a side view of yet another exemplary prior art fluorescent lamp luminary having single ended compact LED lamp installed and shows the resulting incorrect light projection.

FIG. 5 is a partially cut away isometric view of an exemplary single ended compact LED lamp of the invention

FIG. 6 is an isometric view of the exemplary single ended compact LED lamp of the invention of FIG. 5, but oriented so that light is projected straight down through the projection region of the transparent or translucent covering.

FIG. 7 is an isometric view of the exemplary single ended compact LED lamp with its rotatable lamp portion rotated counterclockwise relative to the end cap by about 45 degrees to point in another illumination direction ID₂.

FIG. 8 is another isometric view of the exemplary single ended compact LED lamp of the invention of FIG. 5, but with its rotatable lamp portion rotated counterclockwise relative to the end cap by about 90 degrees to point in another illumination direction ID₃.

FIG. 9 is partial top plan view of another exemplary embodiment of a single ended compact LED lamp of the invention.

FIG. 10 is a top exploded view of the exemplary embodiment of the single ended compact LED lamp of FIG. 9.

FIG. 11 is an isometric end view of a transparent or translucent cover for the single ended compact LED lamp of FIG. 9.

FIG. 12 is an isometric end view of a circuit board for the single ended compact LED lamp of FIG. 9.

FIG. 13 partial top plan view of the exemplary embodiment of a single ended compact LED lamp of FIG. 9 with its transparent or translucent cover removed.

FIG. 14 is a detail view showing the inside of an end cap and prong holder of the single ended compact LED lamp of FIG. 9.

FIG. 15 is an end view of the single ended compact LED lamp of FIG. 9 showing the prong holder screwed to the end cap.

FIG. 16 is a top front isometric view of the swivel base with its spring and ball bearing removed.

FIG. 17 is a top end isometric view of the swivel base with its spring and ball bearing in place.

FIG. 18 is an inside isometric view of the swivel base of FIGS. 16 and 17.

FIG. 19 is a top front isometric view of the end cap showing its ball bearing capture recess.

FIG. 20 is an end view of the end cap pivotally engaged with the swivel base, with the end cap and swivel base rotated about 80 degrees relative to each other.

FIG. 21 is an end view of the end cap pivotally engaged with the swivel base, with the end cap and swivel base not rotated relative to each other.

### DETAILED DESCRIPTION

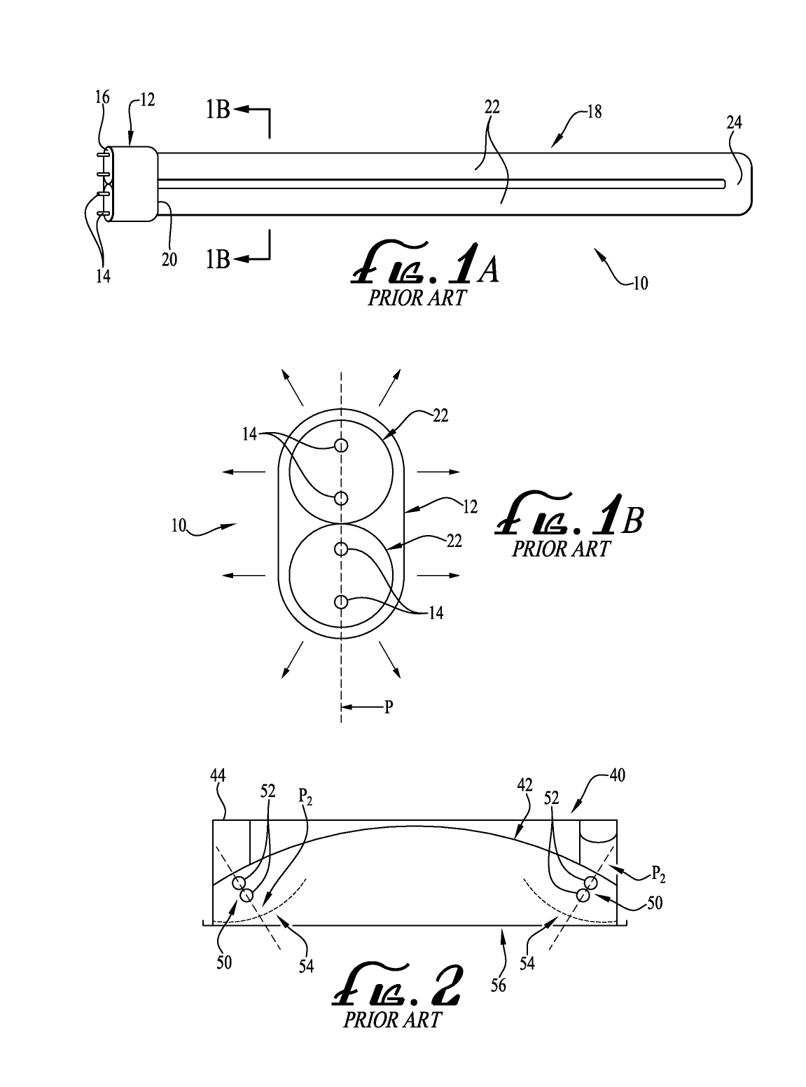

Turning back to FIGS. 1A and 1B, FIG. 1A is a top plan view of a prior art single ended compact fluorescent lamp 10 and FIG. 1B is a cross-section view of same along view lines 1A-1A of FIG. 1A. The art single ended compact fluorescent lamp 10 has a base end 12 with four pins 14 extending from its rear 16. A bulb portion 18 extends from a front 20 of the base end 12, the bulb portion 18 having two elongate straight tube portions 22 connected at their opposite ends 24 by a connecting portion 24. As best shown in FIG. 1B, the two elongate straight tube portions 22 are along a plane P which plane P is parallel to the pins 14. In prior art single ended compact fluorescent lamps 10, light will project around the entire perimeters of the elongate straight tube portions 22 and thus provide fairly even illumination regardless of how the single ended compact fluorescent lamps 10 is positioned in a light fixture.

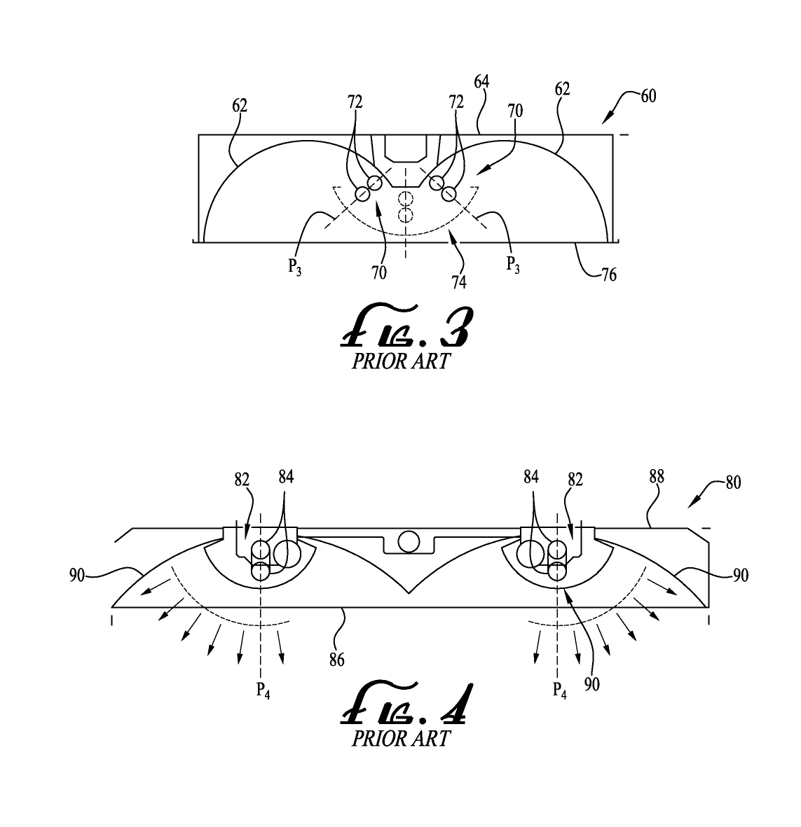

FIG. 2 is a side view of an exemplary prior art fluorescent lamp luminary 40 having a reflector 42 and a back plate 44. Two prior art single ended compact LED lamps 50 are installed therein. As can be seen, imaginary plane lines P₂ pass through two elongate tube portions 52 of each LED lamp 50, and the resulting pattern of light projection is shown by the dashed lines 54 that will project through a front cover 56 of the luminary 40. Because the two prior art single ended compact LED lamps 50 are installed such that the imaginary plane lines P₂ of the two elongate tube portions 52 are not parallel to the front cover 56, the range of light projected is not ideal as it does not project evenly downwardly through the luminary 40.

FIG. 3 is a side view of another exemplary prior art fluorescent lamp luminary 60 having prior art single ended compact LED lamps 70 installed therein. As can be seen, imaginary plane lines P₃ pass through two elongate tube portions 72 of each LED lamp 70, and the resulting pattern of light projection is shown by the dashed lines 74 that will project through a front cover 76 of the luminary 60. As and shows the resulting incorrect light projection with a prior art single ended compact LED lamp installed in any of three orientations.

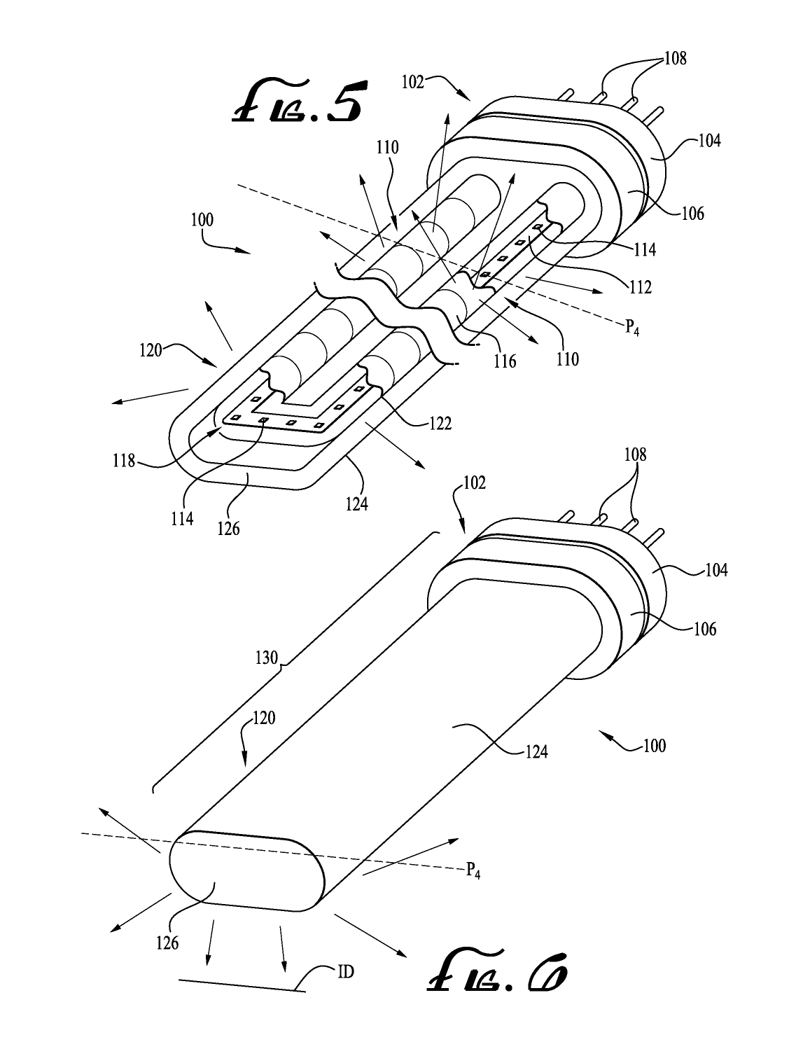

FIG. 4 is a side view of yet another exemplary prior art fluorescent lamp luminary 80 having prior art single ended compact LED lamps 82 installed and shows the incorrect light projection. As can be seen, imaginary plane lines P4 pass through two elongate tube portions 84 of each LED lamp 82, and the resulting pattern of light projection is shown by the dashed lines that will project through a front cover 86 of the luminary 80. The luminary 80 has a back wall 88 and reflectors 90.

FIG. 5 is a partially cut away isometric view of an exemplary single ended compact LED lamp 100 of the invention. It has a swivel connector end 102 that includes an end cap 104 that is rotatably connected to a swivel base 106. Electrical pins 108 extend from the end cap 104, which electrical pins 108 plug into a lamp fixture (not shown.) When the LED lamp 100 is installed in a fixture, the end cap 104 remains stationary. Electrically connected to the swivel base 106 are two LED tubes 110, which each have a circuit board 112 with individual light emitting diodes 114 mounted thereon. Each LED tube 110 has a cover 116, one cover 116 of which is partially cut away to show the circuit board 112 with individual light emitting diodes 114 mounted therein. At ends of the LED tubes 110 opposite where the join to the swivel base 106 there is a union portion 118 that joins the opposite ends of two LED tubes 110. The union portion 118 is also covered by a transparent or translucent cover, which is removed to shown internal construction of the union portion 118. The LED tubes 110 are in turn covered by a transparent or translucent covering 120 having a light projection region 122 and a non-projection region 124. In FIG. 5 a portion of the upper region 122 is partially cut away to show the LED tubes 110 inside the LED lamp 100. The transparent or translucent covering 120 can convenient be made as a continuous extruded or continuous piece and can use a stationary cap 126 that snaps on an open end thereof opposite the swivel connector end 102. Optionally, the transparent or translucent covering 120 can incorporate a transparent or translucent end that is formed along with the transparent or translucent covering 120. Light will accordingly project upwardly and outwardly from an imaginary plane P₄ passing through the individual light emitting diodes 114 on the circuit boards 112 of each LED tube 110, in a range of about 180 to 270 degrees around the LED lamp 100 through the light projection region 122 of the transparent or translucent covering 120. Although the individual LED tubes 110 are shown having individual covers 116, if desired, the individual covers 116 could be left off and with the single ended compact LED lamp 100 covered solely by the transparent or translucent covering 120.

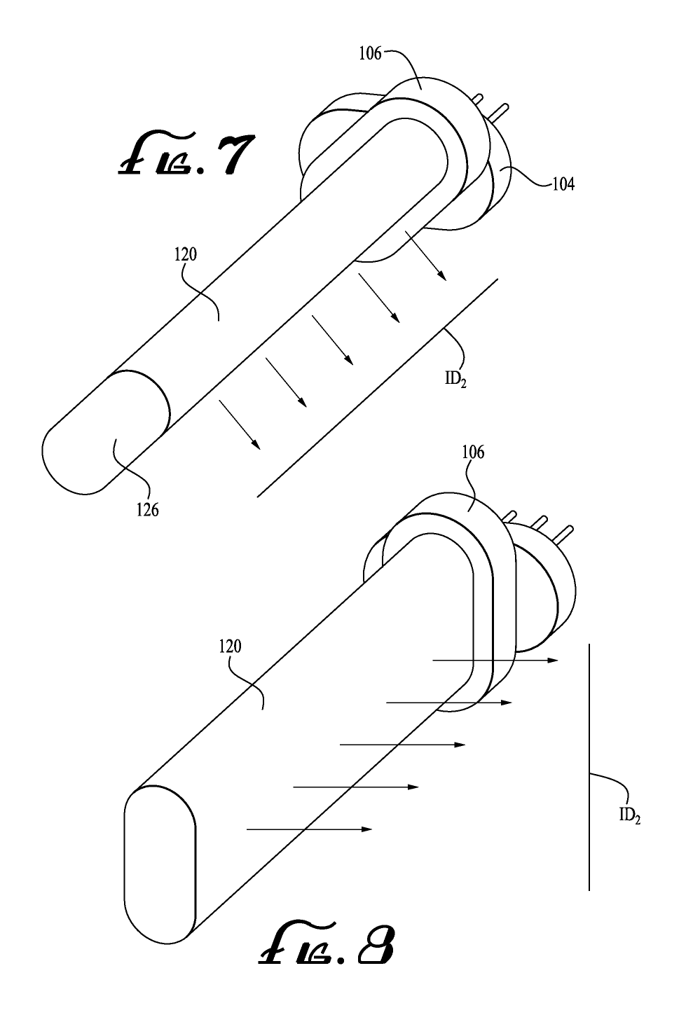

FIG. 6 is an isometric view of the exemplary single ended compact LED lamp 100 of the invention of FIG. 5, but oriented so that light is projected straight down through the projection region 122 of the transparent or translucent covering 120. In this figure, the portion of the LED lamp 100 connected to the swivel base 106 is a rotatable lamp portion 130. The horizontal line ID below the exemplary single ended compact LED lamp 100 represents a desired illumination direction of the lamp. In this case, illumination is provided without rotating the rotatable lamp portion 130 relative to end cap 104 that in turn is plugged into a fixture.

FIG. 7 is an isometric view of the exemplary single ended compact LED lamp 100 of the invention of FIG. 5, but with its rotatable lamp portion 130 rotated counterclockwise relative to the end cap 104 by about 45 degrees to point in another illumination direction ID₂.

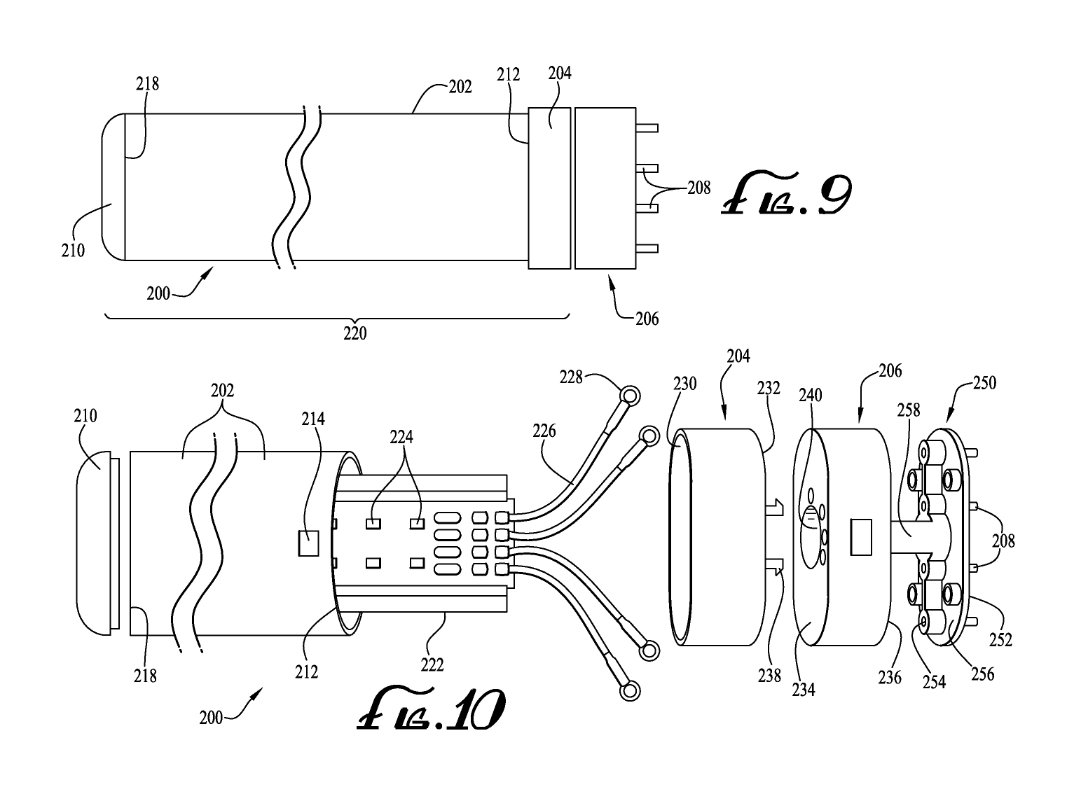

Turning to FIG. 8, there is shown another isometric view of the exemplary single ended compact LED lamp 100 of the invention of FIG. 5, but with its rotatable lamp portion 130 rotated counterclockwise relative to the end cap 104 by about 90 degrees to point in another illumination direction ID₃. Although not shown in the figures, the rotatable lamp portion 130 is likewise rotatable by about 90 degrees in a clockwise direction

FIG. 9 is partial top plan view of another exemplary embodiment of a single ended compact LED lamp 200 of the invention. It has a transparent or translucent cover 202, a swivel base 204, an end cap 206 from which extend electrical prongs 208. The transparent or translucent cover 202 has a two ends 212 and 218. The swivel base 204 and end cap 206 are located near the first end 212 and a stationary cap 210 is located at the second opposite end 218 of the transparent or translucent cover 202. The transparent or translucent cover 202, the swivel base 204, and stationary cap 210 are the lamp portion 220 and are rotatable as a unit relative to the end cap 206 as will be described further below.

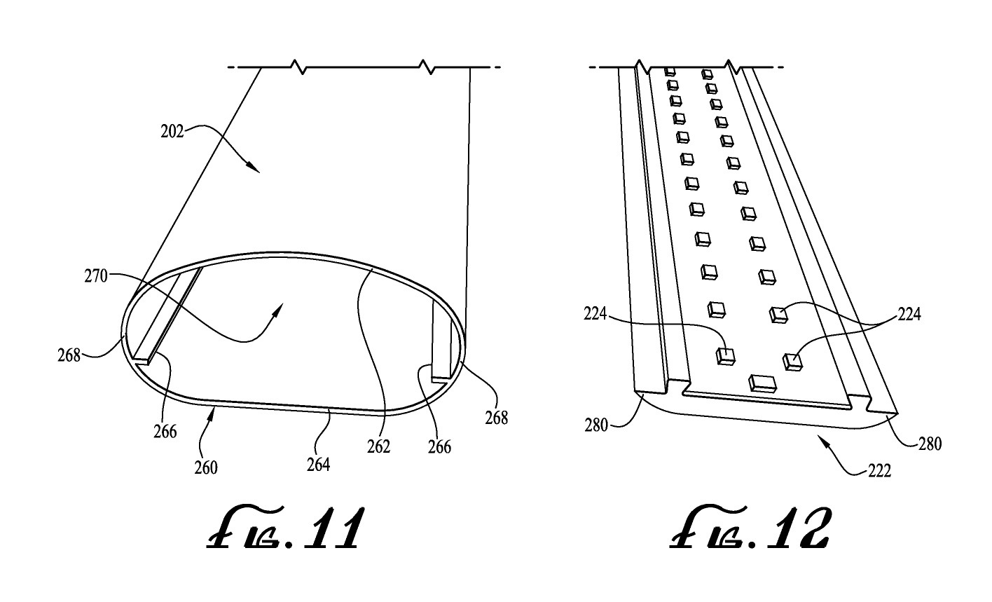

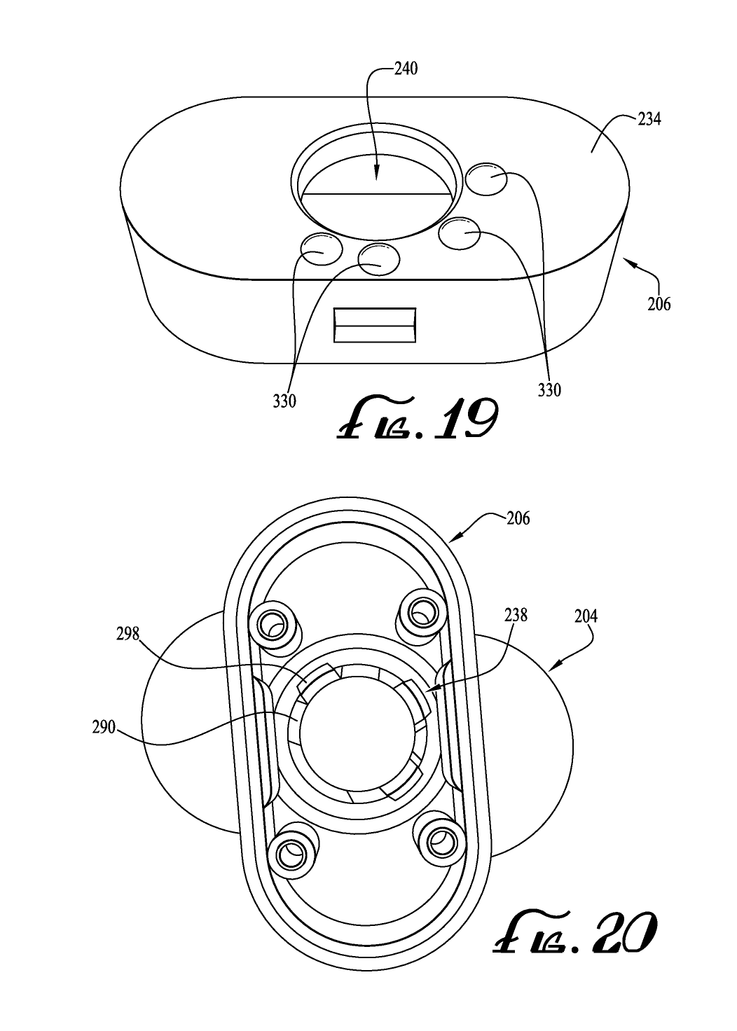

FIG. 10 is a top exploded view of the exemplary embodiment of the single ended compact LED lamp 200 of FIG. 9. The transparent or translucent cover 202, the swivel base 204, end cap 206, and stationary cap 210 are shown. The transparent or translucent cover 202 may optionally include near the first end 212 cutouts 214 that are used to be captured on complementary catches 216 located inside the swivel base 204 (best shown in FIG. 18.) Located inside the transparent or translucent cover 202 is a circuit board 222 with top mounted light emitting diodes (LEDs) 224. Flexible electrical lead wires 226 with wire connectors 228 are attached to the circuit board 222. The swivel base 204 has a rear side 230 and a front side 232 and the end cap 206 has a rear side 234 and a front side 236. Extending from the front side 232 of the swivel base 204 are engagement prongs 238. The engagement prongs 238 are adapted to slide into and be captured in a circular opening 240 formed through the end cap 206, as will be further described below. An electrical prong carrier piece 250 is provided, from which extend from a front side 252 the electrical prongs 208. The electrical prongs 208 have wire connectors 254 accessible from a back side 256 of the electrical prong carrier piece 250. The wire connectors 254 are used to connect to the wire connectors 228 of the lead wires 226, e.g., with screws (not shown.) Also extending from the back side 256 of the electrical prong carrier piece 240 is a hollow wire guide sleeve 258, through which the lead wires 226 will be passed. As shown in FIG. 13, when assembled, the swivel base 204 and end cap 206 will rotatable snap together with the engagement prongs 238 passing into the circular opening 240 formed through the end cap 206 and capturing therein, with the lead wires 226 passing through the circular opening 240.

FIG. 11 is an isometric end view of the transparent or translucent cover 202. It has a wall 260 with an upper region 262 and a lower region 264 and two internally located rail guides 266 located at two sides 268 of the wall 260. The transparent or translucent cover 202 defines an internal space 270. The purpose of the two internally located rail guides 266 is to retain the circuit board 222 inside the internal space 270 adjacent to the lower region 264 of the transparent or translucent cover 202.

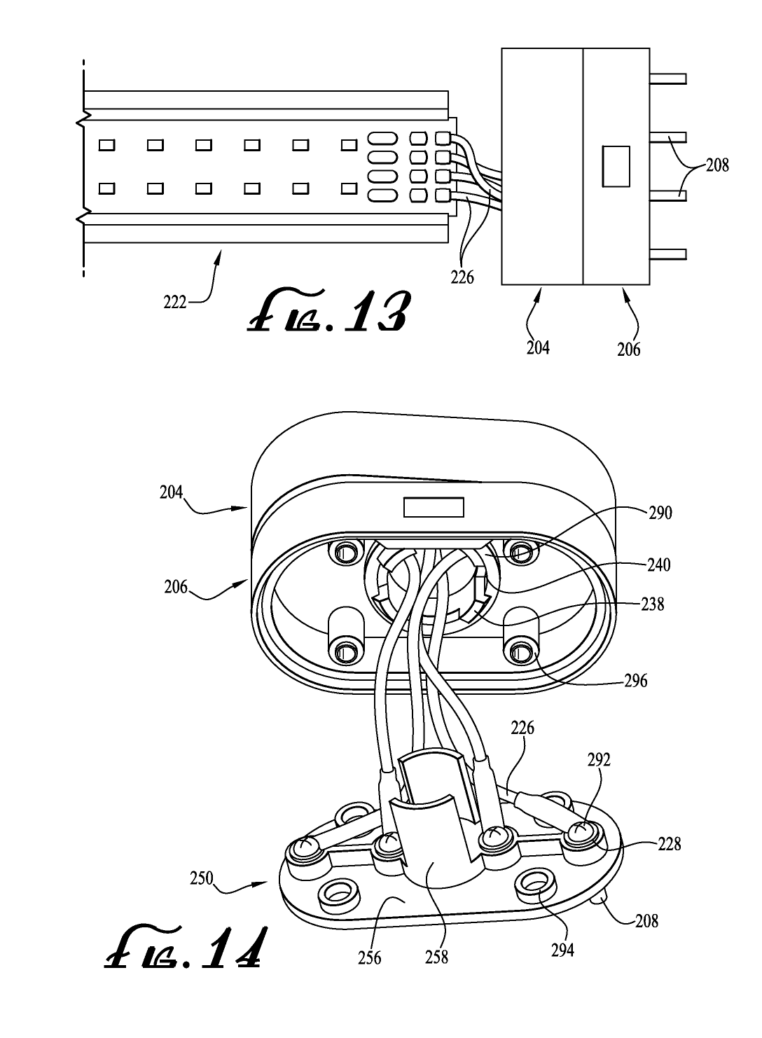

FIG. 12 is an isometric end view of the circuit board 222 with light emitting diodes 224 mounted thereon. The circuit board 222 has two side edges 280 for the single ended compact LED lamp of FIG. 9. The circuit board 222 will thus be able to be slid into the internal space 270 of the transparent or translucent cover 202 with its side edges 280 being captured by the two internally located rail guides 266 located at two sides 268 of the wall 260, as shown in FIG. 10.

FIG. 13 partial detail top plan view of the exemplary embodiment of a single ended compact LED lamp 200 of FIG. 9 with the transparent or translucent cover removed, and showing the electrical lead wires 226 passing from the circuit board 222 to the swivel base 204 which is connected to the end cap 206.

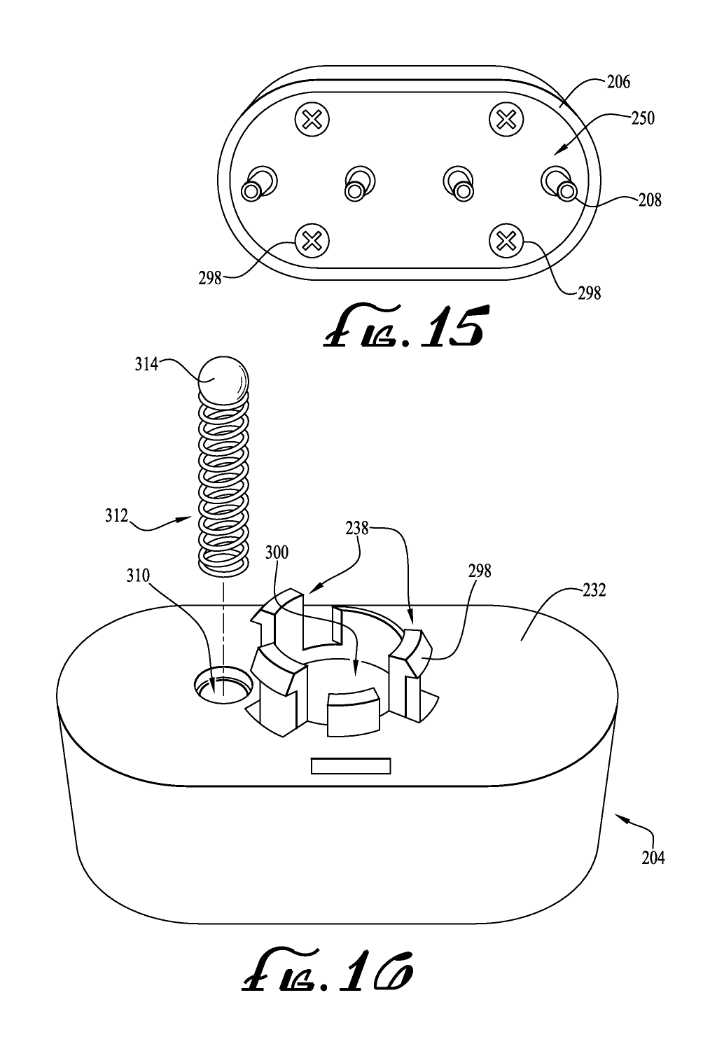

FIG. 14 is a detail view showing the inside of the end cap 206 and prong holder 250 of the single ended compact LED lamp 200 of FIG. 9. The swivel base 204 rotatably connects to the end cap 206 by virtue of engagement prongs 238 passing through the circular opening 240 formed through the end cap 206 and seating on a rim 290 inside the end cap 206. The electrical lead wires 226 pass through the engagement prongs 238 of swivel base 204 and the circular opening 240. Screws 292 connect the wire connectors 228 at the ends of the electrical lead wires 226 to the wire connectors 254 (not shown) of the electrical prongs 208. The prong holder 250 has screw holes 294 formed therein. The prong holder 250 is brought into contact with the front side 236 of the end cap 206 and attachment screws 298 pass through the screw holes 294 and engage with lugs 296 on the end cap 206, as best shown in FIG. 15.

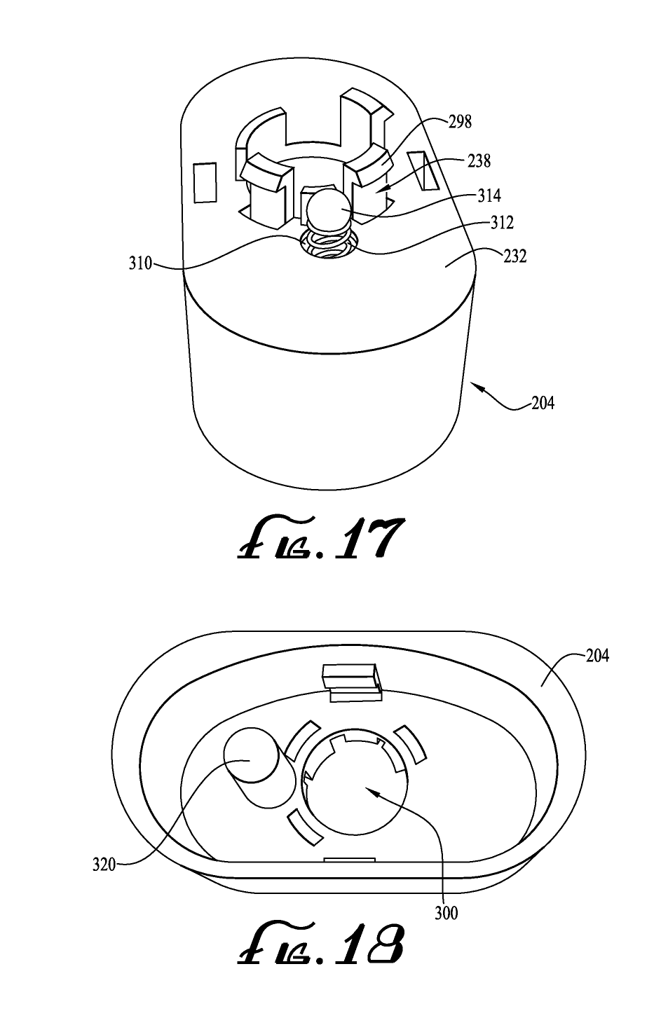

FIG. 16 is a top front isometric view of the swivel base 204 and FIG. 17 is a top end isometric view of the swivel base 204. As can be seen, extending above the front side 232 of the end cap 206 are the engagement prongs 238. The engagement prongs 238 have hooks 298 at ends and the engagement prongs 238 flex inwardly when engaged with the circular opening 240 formed through the end cap 206. Also located at the front side 232 of the swivel base 204 is a spring recess 310, which spring recess 310 will receive a coil spring 312. Also shown is a ball bearing 314 which will sit on top of the coil spring 312 when it is inserted in the spring recess 310, as best shown in FIG. 17. The coil spring 312 will bias the ball bearing 314 upwardly away from the front side 232 of the end cap 206 but will also allow the ball bearing 314 and its spring 312 to be pushed down into the spring recess 310.

FIG. 18 is an inside isometric view of the swivel base 204 of FIGS. 16 and 17 and shows a closed end tube 320 that defines the spring recess 310.

FIG. 19 is a top front isometric view of the end cap 206 showing its rear side 234, which has a plurality of ball bearing capture recesses 330 formed therein and spaced around the circular opening 240. When the swivel base 204 and end cap 206 are snapped together, the spring loaded ball bearing 314 will align with and be captured in one of the ball bearing capture recesses 330 of the end cap 206 and therefore retain the orientation of the lamp portion 220 relative to the end cap 206. This feature will help retain a desired rotational orientation of the lamp portion 220 relative to the end cap 206. If a user wishes to change the rotational orientation of the lamp portion 220 relative to the end cap 206, the user will simply twist the lamp portion 220 relative to the end cap 206, which will cause the ball bearing 314 and its coil spring 312 to be pushed back down into the spring recess 310 until it is positioned to snap into another ball bearing capture recesses 330. This rotation position selection feature will ensure that once a rotational orientation of the LED lamp is selected, it will remain unchanged unless and until a user physically twists the LED lamp relative to the end cap. Also, while the coil spring 312 is shown as be retained in the spring recess 310 in the swivel base 204 with the ball bearing capture recesses 330 shown as formed on the end cap 206, if desired the locations of the coil spring 312, the spring recess 310, and ball bearing capture recesses 330 can be switched with the coil spring 312 and the spring recess 310 being located in the end cap and with the ball bearing capture recesses 330 be located on the swivel base 204.

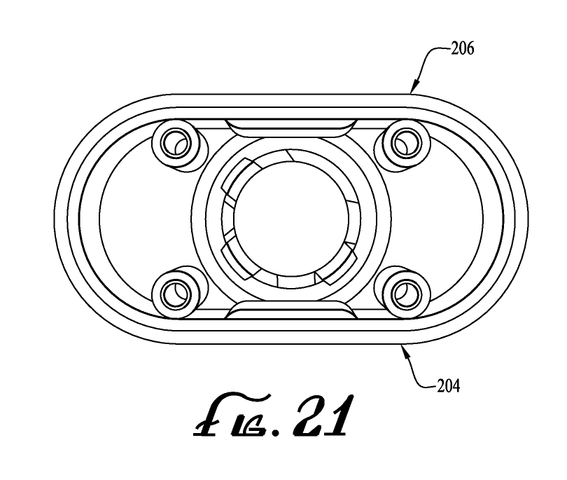

FIG. 20 is an end view of the end cap 206 pivotally engaged with the swivel base 204, with the end cap and swivel base rotated about 80 degrees relative to each other. As shown, the hooks 298 of the engagement prongs 238 will ride on the rim 290 inside the end cap 206. FIG. 21 is an end view of the end cap 204 pivotally engaged with the swivel base 206, but with the end cap 206 and swivel base 204 not rotated relative to each other.

Thus, the single ended compact LED lamps 100 and 200 of the invention can be used in light fixtures having plugs that are orientated such that their use with standard replacement LED would result in improper light projection. As noted herein, however with the LED lamps 100 and 200 of the invention, since the rotatable lamp portions 130 and 220 is rotatable relative to the end caps 104 and 206, the prefect direction of light illumination can be set regardless of the design of the light fixture.

The preferred embodiments of this invention have been disclosed, however, so that one of ordinary skill in the art would recognize that certain modifications would come within the scope of this invention.

What is claimed is:

1. A rotatable single ended compact LED lamp for use in a light fixture, the rotatable single ended compact LED lamp comprising:
a single ended LED lamp having (a) a circuit board with a top surface and with light emitting diodes located on the circuit board to project light away from the top surface thereof, the circuit board having a first end with electrical leads and a second end opposite the first end, there being an imaginary circuit board plane that is parallel to the top surface of the circuit board, (b) a transparent or translucent cover with a first end and a second end, the transparent or translucent cover being spaced over the circuit board, and (c) a swivel base having a rear side and a front side that is opposite the rear side, the circuit board and the transparent or translucent cover being non-rotatably connected at their second ends to the rear side of a swivel base;
an end cap having a front side with electrical connectors, and a rear side opposite the front side, the end cap having an imaginary longitudinal plane passing through the front side and the rear side, the end cap being rotatably coupled at its rear side to the front side of the swivel base; and
a rotation position selection device for positioning the single ended LED lamp, the transparent or translucent cover, and its swivel base in one of a plurality of rotational orientations relative to the end cap, wherein when the single ended LED lamp, the transparent or translucent cover, and its swivel base are rotated relative to the end cap, a rotational orientation of the single ended LED lamp relative to the end cap is changed and the imaginary circuit board plane will rotate relative to the imaginary end cap longitudinal plane.

2. The rotatable single ended compact LED lamp of claim 1, wherein one of the swivel base and the end cap include a protrusion and the other of the swivel base and the end cap include a recess into which the protrusion rotatably engages along a rotational axis, wherein the electrical leads comprise flexible wires, which flexible wires pass through the protrusion and recess and are electrically connected to the electrical connectors so that electrical power may be provided to the single ended LED lamp regardless of the rotational orientation of the single ended LED lamp relative to the end cap.

3. The rotatable single ended compact LED lamp of claim 1, wherein the circuit board has two spaced apart parallel lines of light emitting diodes located thereon.

4. The rotatable single ended compact LED lamp of claim 1, wherein the transparent or translucent cover has a flatten tube shape with a wall and defining an inner space, and having circuit board retainers protruding from an inside of the wall to retain the circuit board inside the inner space of the cover.

5. The rotatable single ended compact LED lamp of claim 1, further comprising a stationary cap for attachment to the first end of the transparent or translucent cover.

6. The rotatable single ended compact LED lamp of claim 1, wherein the electrical connectors are positioned on an electrical prong carrier piece that attached to the front side of the end cap.

7. The rotatable single ended compact LED lamp of claim 6, wherein the electrical connectors comprises a plurality of elongate prongs, each prong having a front region that extends forward of a front side of the electrical prong carrier piece and a rear end that is accessible from a rear side of the electrical prong carrier piece, the rear end of each prong being electrically connected to one of the electrical leads.

8. The rotatable single ended compact LED lamp of claim 1, wherein the rotation position selection feature comprises a coil spring, a spring recess formed on one of the front side of the swivel base or the rear side of the end cap, a plurality of ball bearing capture recesses formed on the other of the rear side of the end cap or the front side of the swivel base, and ball bearing, with the coil spring placed in the spring recess with the ball bearing positioned on a free end of the coil spring extending out of the spring recess, wherein when the end cap and swivel base are connected together, the ball bearing will selectively be captured in one of the plurality of ball bearing capture recesses depending on a rotational orientation of the end cap relative to the swivel base.

9. The rotatable single ended compact LED lamp of claim 1, wherein the single ended LED lamp has two spaced apart elongate LED lamp portions each with a first end and a second end, a circuit board with a top surface and with light emitting diodes located on the circuit board to project light away from the top surface, and further comprising a LED bridging portion for bridging the two LED lamp portions near their first ends, the LED tube portions being non-rotatably and electrically connected at their second ends to the first side of a swivel base.

10. The rotatable single ended compact LED lamp of claim 9, wherein the LED bridging portion is integral with the two spaced apart elongate LED lamp portions and includes a circuit board with light emitting diodes.

11. A rotatable single ended compact LED lamp for use in a light fixture, the rotatable single ended compact LED lamp comprising:
a single ended LED lamp having (a) a circuit board with a top surface and with light emitting diodes located on the circuit board to project light away from the top surface thereof, the circuit board having a first end with electrical leads and a second end opposite the first end, there being an imaginary circuit board plane that is parallel to the top surface of the circuit board, (b) a transparent or translucent cover with a first end and a second end, the transparent or translucent cover being spaced over the circuit board, and (c) a swivel base having a rear side and a front side that is opposite the rear side, the circuit board and the transparent or translucent cover being non-rotatably connected at their second ends to the rear side of a swivel base;
an end cap having a front side with electrical connectors, and a rear side opposite the front side, the end cap having an imaginary longitudinal plane passing through the front side and the rear side, the end cap being rotatably coupled at its rear side to the front side of the swivel base; and
a rotation position selection device for positioning the single ended LED lamp, the transparent or translucent cover, and its swivel base in one of a plurality of rotational orientations relative to the end cap, wherein when the single ended LED lamp, the transparent or translucent cover, and its swivel base are rotated relative to the end cap, a rotational orientation of the single ended LED lamp relative to the end cap is changed and the imaginary circuit board plane will rotate relative to the imaginary end cap longitudinal plane; wherein one of the swivel base and the end cap include a protrusion and the other of the swivel base and the end cap include a recess into which the protrusion rotatably engages along a rotational axis, wherein the electrical leads comprise flexible wires, which flexible wires pass through the protrusion and recess and are electrically connected to the electrical connectors so that electrical power may be provided to the single ended LED lamp regardless of the rotational orientation of the single ended LED lamp relative to the end cap.

12. The rotatable single ended compact LED lamp of claim 11, wherein the circuit board has two spaced apparat parallel lines of light emitting diodes located thereon.

13. The rotatable single ended compact LED lamp of claim 11, wherein the transparent or translucent cover has a flatten tube shape with a wall and defining an inner space, and having circuit board retainers protruding from an inside of the wall to retain the circuit board inside the inner space of the cover.

14. The rotatable single ended compact LED lamp of claim 11, further comprising a stationary cap for attachment to the first end of the transparent or translucent cover.

15. The rotatable single ended compact LED lamp of claim 11, wherein the electrical connectors are positioned on an electrical prong carrier piece that attached to the front side of the end cap.

16. The rotatable single ended compact LED lamp of claim 15, wherein the electrical connectors comprises a plurality of elongate prongs, each prong having a front region that extends forward of a front side of the electrical prong carrier piece and a rear end that is accessible from a rear side of the electrical prong carrier piece, the rear end of each prong being electrically connected to one of the electrical leads.

17. The rotatable single ended compact LED lamp of claim 11, wherein the rotation position selection feature comprises a coil spring, a spring recess formed on one of the front side of the swivel base or the rear side of the end cap, a plurality of ball bearing capture recesses formed on the other of the rear side of the end cap or the front side of the swivel base, and ball bearing, with the coil spring placed in the spring recess with the ball bearing positioned on a free end of the coil spring extending out of the spring recess, wherein when the end cap and swivel base are connected together, the ball bearing will selectively be captured in one of the plurality of ball bearing capture recesses depending on a rotational orientation of the end cap relative to the swivel base.

18. A rotatable single ended compact LED lamp for use in a light fixture, the rotatable single ended compact LED lamp comprising:
a single ended LED lamp having a circuit board with light emitting diodes located on the circuit board, a transparent or translucent cover which covers the circuit board and light emitting diodes, and a swivel base to which the circuit board and the transparent or translucent cover are non-rotatably connected;
an end cap which is rotatably coupled to the swivel base, the end cap having electrical prongs extends therefrom; and
a rotation position selection device for positioning the single ended LED lamp, the transparent or translucent cover, and its swivel base in one of a plurality of rotational orientations relative to the end cap, wherein when the single ended LED lamp, the transparent or translucent cover, and its swivel base are rotated relative to the end cap, a rotational orientation of the single ended LED lamp relative to the end cap is changed.

19. The rotatable single ended compact LED lamp of claim 18, wherein the single ended LED lamp further comprises flexible electrical wires that are attached at first ends to the circuit board and at second ends to the electrical prongs of the end cap, and wherein one of the swivel base and the end cap include a protrusion and the other of the swivel base and the end cap include a recess into which the protrusion rotatably engages along a rotational axis, wherein the flexible electrical wires pass through the protrusion and recess so that electrical power may be provided to the single ended LED lamp regardless of the rotational orientation of the single ended LED lamp relative to the end cap.

20. The rotatable single ended compact LED lamp of claim 18, wherein the transparent or translucent cover has a flatten tube shape with a wall and defining an inner space, and having circuit board retainers protruding from an inside of the wall to retain the circuit board inside the inner space of the cover.

21. The rotatable single ended compact LED lamp of claim 18, further comprising a stationary cap for attachment to the first end of the transparent or translucent cover.

22. The rotatable single ended compact LED lamp of claim 18, further comprising an electrical prong carrier piece that attached to the front side of the end cap, and wherein the electrical connectors comprise a plurality of elongate prongs that are positioned so that front regions of the elongate prongs extend forward of a front side of the electrical prong carrier piece and so that rear ends of the elongate prongs are accessible from a rear side of the electrical prong carrier piece, the rear ends of each prong being electrically connected to one of the electrical leads.

23. The rotatable single ended compact LED lamp of claim 18, wherein the rotation position selection feature comprises a coil spring, a spring recess formed on one of a front side of the swivel base or a rear side of the end cap, a plurality of ball bearing capture recesses formed on the other of the rear side of the end cap or the front side of the swivel base, and ball bearing, with the coil spring placed in the spring recess with the ball bearing positioned on a free end of the coil spring extending out of the spring recess, wherein when the end cap and swivel base are connected together, the ball bearing will selectively be captured in one of the plurality of ball bearing capture recesses depending on a rotational orientation of the end cap relative to the swivel base.
